(19) United States
(12) Patent Application Publication
(10) Pub. No.: US 2026/0030824 A1
(43) Pub. Date: Jan. 29, 2026

(54) REALTIME INTERACTIONS BETWEEN A USER AND AN IN-VEHICLE ASSISTANT SYSTEM

(71) Applicant: NIO TECHNOLOGY (ANHUI) CO., LTD., Hefei (CN)

(72) Inventors: Emmanuel Saez, Saratoga, CA (US); Jeremy Richards, San Jose, CA (US); Benjamin Rowland, Sunnyvale, CA (US); Cinna Soltanpur, San Jose, CA (US)

(73) Assignee: NIO TECHNOLOGY (ANHUI) CO., LTD., Hefei (CN)

(21) Appl. No.: 18/783,448

(22) Filed: Jul. 25, 2024

(51) Int. Cl. G06T 13/80; G06F 40/205; G06V 40/16; G06V 40/20

(52) U.S. Cl. CPC G06T 13/80; G06F 40/205; G06V 40/176; G06V 40/28

(57) ABSTRACT

Embodiments of the present disclosure provide a real-time response to a user sitting in a vehicle, such as a driver/passenger. A plurality of images of the user may be captured by a camera disposed in the vehicle. These images may be sent to a control system for processing and outputting a set of user state indicators for characterizing the user's state. Based on the set of user state indicators, an assistant system may programmatically generate one or more animated visual presentations and display the same on a screen of an assistant device as the response to the user's state upon receiving a command sent by the control system. Additionally, the assistant system may also control the physical movement of the assistant device upon receiving a command sent by the control system as the response to the user's head movement.

### BACKGROUND

The present disclosure generally relates to vehicles. Particularly, the present disclosure relates to human-machine interaction in vehicles.

With the rapid development of electric vehicles, many vehicles have been equipped with a human-machine interactive device, called an in-vehicle virtual assistant device, to help the driver/passengers accomplish many tasks traditionally handled by the driver/passenger himself/herself manually. Usually, the in-vehicle assistant device can perform tasks for the driver/passenger based on the interactions with the vehicle control system through voice commands or text input. However, these mediums of interaction are insufficient to convey information regarding the driver/passenger to boost the driving/riding experience. As such, there is a need for a human-machine interaction system used in a vehicle based on additional interactive media, such as visual information about the driver/passengers.

### BRIEF SUMMARY

Embodiments of the present disclosure provide a real-time response to a user sitting in a vehicle, such as a driver/passenger. A plurality of images of the user may be captured by an image capture device, such as a camera disposed in the vehicle. These images may be sent to a control system for processing and outputting a set of user state indicators for characterizing the user's state, including the user's facial expression, the user's head movement, and/or the user's hand gesture. Based on the set of user state indicators, an assistant system may programmatically generate one or more animated visual presentations and display the same on a screen of an assistant device as the response to the user's facial expression and/or the user's hand gesture upon receiving a command sent by the control system. Additionally, the assistant system may also control the physical movement of the assistant device, such as the head of the assistant device, upon receiving a command sent by the control system as the response to the user's head movement. In another aspect, some embodiments of the present disclosure may also use the animated visual presentations displayed on the screen of the assistant device to play an interacting game, such as a paper-rock-scissor game, with the user.

Some embodiments of the present disclosure propose a method for in-vehicle interaction. The method may include: receiving commands, by an assistant system, wherein each of the commands contains a set of person state indicators characterizing a person's state at a given time; parsing, by the assistant system, each of the commands to obtain the set of person state indicators; constructing, by the assistant system, a plurality of keyframes based on the set of person state indicators; animating, by the assistant system, the plurality of keyframes to form an animated visual presentation; and displaying, by the assistant system, the animated visual presentation on a screen of the assistant system.

In some embodiments, the set of person state indicators may include a facial expression indicator for characterizing the person's facial expression, and each of the keyframes includes a facial component. Constructing, by the assistant system, the plurality of keyframes based on the set of person state indicators includes: generating the facial component on each of the keyframes based on the facial expression indicator.

In some embodiments, generating the facial component on each of the keyframes based on the facial expression indicator includes: determining a particular facial element from a set of facial elements, wherein the particular facial element correlates to the facial expression indicator; and generating the facial component using the particular facial element.

In some embodiments, the set of person state indicators includes a hand gesture indicator for characterizing the person's hand gesture, and each of the keyframes includes a hand component. Constructing, by the assistant system, the plurality of keyframes based on the set of person state indicators includes: generating the hand component on each of the keyframes based on the hand gesture indicator.

In some embodiments, generating the hand component on each of the keyframes based on the hand gesture indicator includes: determining a particular hand element from a set of hand elements, wherein the particular hand element correlates to the hand gesture indicator; and generating the hand component using the particular hand element.

In some embodiments, each of the keyframes includes an accessory component. Constructing, by the assistant system, the plurality of keyframes based on the set of person state indicators includes: generating the accessory component on each of the keyframes using a particular accessory element independently selected from a set of accessory elements.

In some embodiments, each of the keyframes includes a background component. Constructing, by the assistant system, the plurality of keyframes based on the set of person state indicators includes: generating the background component on each of the keyframes using a particular background element independently selected from a set of background elements.

In some embodiments, the set of person state indicators includes a head movement indicator for characterizing the person's head movement. The method further includes: causing physical movement of a head of the assistant system based on the head movement indicator.

In some embodiments, causing physical movement of the head of the assistant system based on the head movement indicator includes: determining a particular motion vector from a set of motion vectors, wherein the particular motion vector correlates to the head movement indicator; and controlling rotation of motors mounted on the assistant system according to the particular motion vector.

In some embodiments, the method further includes: receiving, by a control system, a plurality of images of the person, wherein each of the plurality of images includes visual information regarding the person's state; processing, by the control system, each of the plurality of images to obtain the set of state indicators characterizing the person's states; and sending, by the control system, commands to the assistant system, wherein each of the commands contains the set of person state indicators.

In some embodiments, the set of person state indicators includes a facial expression indicator, a hand gesture indicator, a head movement indicator, or any combination thereof, the method further includes: storing a predetermined numeric threshold corresponding to each of the person state indicators in the set of person state indicators; and determining that at least one person state indicator in the set of person state indicators has a numeric value that equals to or is greater than the predetermined numeric value threshold corresponding to the at least one person state indicator.

Some embodiments of the present disclosure propose an in-vehicle interactive system including an assistant system including a screen, a hardware portion, an assistant storage device, and an assistant processor. The assistant storage device stores instructions which, when executed by the assistant processor, causes the assistant system to: receive commands, wherein each of the commands contains a set of person state indicators characterizing a person's state at a given time; parse each of the commands to obtain the set of person state indicators construct a plurality of keyframes based on the set of person state indicators; animate the plurality of keyframes to form an animated visual presentation; and display the animated visual presentation on the screen of the assistant system.

In some embodiments, the set of person state indicators includes a facial expression indicator for characterizing the person's facial expression, and each of the keyframes includes a facial component. Constructing the plurality of keyframes based on the set of person state indicators includes: generating the facial component on each of the keyframes based on the facial expression indicator.

In some embodiments, generating the facial component on each of the keyframes based on the facial expression indicator includes: determining a particular facial element from a set of facial elements, wherein the particular facial element correlates to the facial expression indicator; and generating the facial component using the particular facial element.

In some embodiments, the set of person state indicators includes a hand gesture indicator for characterizing the person's hand gesture, and each of the keyframes includes a hand component. Constructing a plurality of keyframes based on the set of user state indicators includes: generating the hand component on each of the keyframes based on the hand gesture indicator.

In some embodiments, generating the hand component on each of the keyframes based on the hand gesture indicator includes: determining a particular hand element from a set of hand elements, wherein the particular hand element correlates to the hand gesture indicator; and generating the hand component using the particular hand element.

In some embodiments, each of the keyframes includes an accessory component. Constructing the plurality of keyframes based on the set of person state indicators includes: generating the accessory component on each of the keyframes using a particular accessory element independently selected from a set of accessory elements.

In some embodiments, each of the keyframes includes a background component. Constructing the plurality of keyframes based on the set of person state indicators includes: generating the background component on each of the keyframes using a particular background element independently selected from a set of background elements.

In some embodiments, the set of person state indicators includes a head movement indicator for characterizing the person's head movement, and wherein execution of the instructions further causes the assistant system to: cause physical movement of the hardware portion based on the head movement indicator.

In some embodiments, causing physical movement of the hardware portion based on the head movement indicator includes: determining a particular motion vector from a set of motion vectors, wherein the particular motion vector correlates to the head movement indicator; and controlling rotation of motors mounted on the hardware portion based on the particular motion vector.

In some embodiments, the in-vehicle interactive system further includes a control system communicatively coupled with the assistant system. The control system includes a control storage device and a control processor, the control storage device storing instructions which, when executed by the control processor, causes the control system to: receive a plurality of images of the person, wherein each of the plurality of images includes visual information regarding the person's state; process each of the plurality of images to obtain the set of person state indicators characterizing the person's states; and send commands to the assistant system, wherein each of the commands contains the set of person state indicators.

In some embodiments, the set of person state indicators includes a facial expression indicator, a hand gesture indicator, a head movement indicator, or any combination thereof, and execution of the instructions further causes the control system to: store a predetermined numeric threshold corresponding to each of the person state indicator in the set of person state indicators; and determine that at least one person state indicator in the set of person state indicators has a numeric value that equals to or is greater than the predetermined numeric threshold corresponding to the at least one person state indicators.

Numerous benefits may be provided by various embodiments of the present disclosure. Some embodiments of the present disclosure provide a real-time animation to reflect or react to the user's state, such as facial expression and/or body gesture. The real-time animation is dynamically programmed as the user's facial expression and/or body gesture changes. The real-time animation may be interpreted by the user as the in-vehicle assistant device is interacting with him/her, providing the user with a human-companion like experience. The real-time animation may provide a smoother approach than traditional pre-rendered animation frames and may allow for more control of the animation process during runtime. In addition, the present disclosure may also provide real-time control of the physical movement of the in-vehicle assistant as the user moves his/her head. The physical movement of the in-vehicle assistant device may be interpreted by the user as the in-vehicle assistant device is interacting with him/her, providing the user with a human-companion like experience. Embodiments of the present disclosure may significantly improve the in-vehicle human-machine interactions. These and other benefits may be apparent from the following illustrative description of the present disclosure.

### BRIEF DESCRIPTION OF THE DRAWINGS

FIG. 1 shows a schematic diagram of an example vehicle environment according to present disclosure.

FIG. 2 shows a process flow chart performed by the assistant system according to some embodiments of the present disclosure.

FIG. 3 shows an example of a keyframe of the animation.

FIG. 4A shows some examples of the facial elements according to some embodiments of the present disclosure.

FIG. 4B shows some examples of the hand elements according to some embodiments of the present disclosure.

FIG. 4C shows some examples of the accessory elements according to some embodiments of the present disclosure.

FIG. 5 shows a diagram of the assistant device according to some embodiments of the present disclosure.

FIGS. 6A-6B show a flow chart of the method for in-vehicle interaction according to some embodiments of the present disclosure, wherein FIG. 6A shows the steps performed by the control system according to some embodiments, and FIG. 6B shows the steps performed by the assistant system according to some embodiments.

FIG. 7 is a simplified schematic diagram illustrating a computing system according to an embodiment described herein.

### DETAILED DESCRIPTION

The present disclosure contemplates to improve the user experience, safety, and comfort through a real-time response to user's states. The user's states may be characterized by the user's facial expression, the user's hand gesture, and the user's head movement. Some embodiments of the present disclosure may include a control system, a camera, an assistant system, and an assistant device. The camera is provided in the interior of the vehicle and can capture images of a user, e.g., a driver/passenger. The captured images can be processed by a machine learning model to generate a set of landmarks characterizing the user's facial expressions, hand gestures, and head movement. A set of user state indicators may be output by the machine learning model. The assistant system may use the set of user state indicators to dynamically generate one or more animated visual presentations and control the physical movement of the head of the assistant device. Then the assistant system may play the one or more animated visual presentations on the screen of the assistant device as a response to the user's state. In addition, the assistant system can control the physical movement of the head of the assistant device as response to the user's state. Further, the state of the user can play in more complex interactions, such as playing a two-player game between the assistant device and the user, for example, a rock-paper-and-scissors game.

### System Environment

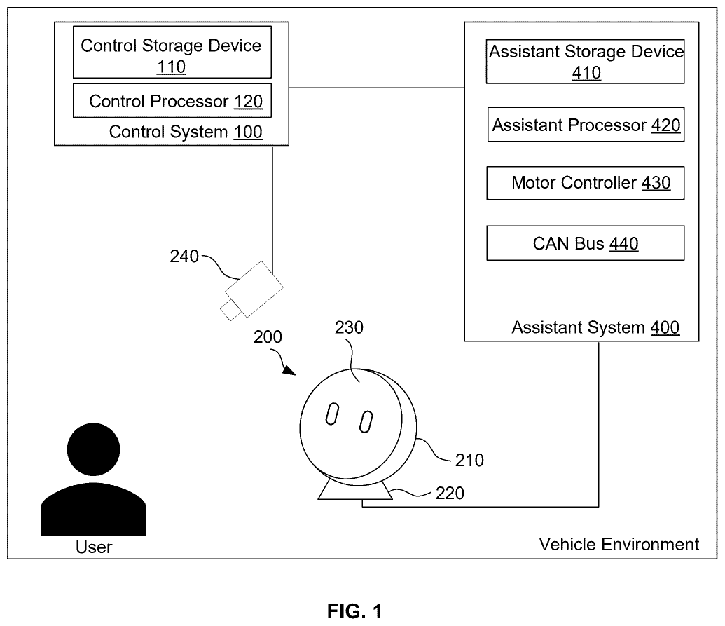

FIG. 1 shows a schematic diagram of an example vehicle environment including an example assistant device for interacting with a user in the environment, according to some embodiments. In some embodiments, the environment depicts a vehicle (e.g., a vehicle system), such as an interior of a vehicle including a control system 100, at least one camera 240, and an assistant system 400 communicatively coupled to the control system 100. In some embodiments, the control system 100 may be a computing device including at least one control storage device 110 and at least one control processor 120. Instructions may be stored in the control storage device 110 to perform varieties of control of the vehicle. In some embodiments, the control system 100 may be disposed in the vehicle. In some other embodiments, the control system 100 may be a remote cloud server wirelessly connected to the central vehicle control computer.

The example vehicle environment may include a camera 240 placed in the interior of the vehicle at a suitable position. For example, the camera 240 may be mounted at the position of the interior rearview mirror, or at a position close to the inner roof of the vehicle compartment. The position of the camera 240 is not limited by the present disclosure, provided that the camera 240 may capture images of the user's face and upper body. As used herein, the user may refer to a driver or a passenger sitting in the interior of the vehicle.

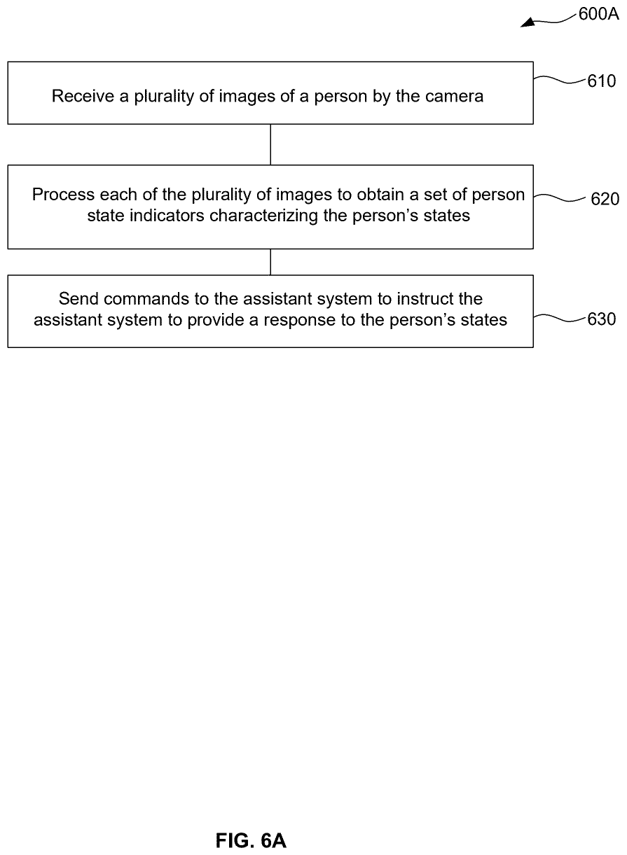

In some embodiments, the assistant system 400 includes one or more computing devices containing at least one assistant storage device 410, at least one assistant processor 420, a motor controller 430, and a CAN bus 440. The assistant system 400 also includes the assistant device 200 which may be referred to as the hardware portion of the assistant system 400. In some embodiments, the assistant device 200 is disposed in the interior of the vehicle to implement human-vehicle interactions. The assistant device 200 may include a head 210 rotatably mounted on a base 220, which will be described below in detail. In some embodiments, the CAN bus 440 may provide connections between the at least one assistant storage device 410, the at least one assistant processor 420, and the motor controller 430 for data exchange. In some embodiments, the motor controller 430 may control motors mounted in the assistant device 200 to physically move the head of the assistant device 200. It should be noted that, as used herein, the terms “control” and “assistant” should be understood to distinguish different systems, and are not used to define the status of systems. The head 210 may include a screen 230 and multiple motors (shown in FIG. 5). Based on commands received from the at least one control processor 120 of the control system 100, the assistant system 400 may control the motors of the assistant device 200 through the motor controller 430 to rotate the head 210 with respect to the base 220, for example, yawing, pitching, and/or rolling. In addition, the assistant device 200 may display contents on its screen 230, which will be described below in detail.

As shown in FIG. 1, the control system 100 is connected through wire connection or wireless connection with the assistant system 400 for data transmission between the control system 100 and the assistant system 400. Images captured by the camera 240 can be fed into the control system 100 for processing, which will be described in detail below.

### Image Capture and Processing

In some embodiments, the camera 240 may capture images of the user sitting in the interior of the vehicle. In some instances, the camera 240 may capture a single image or a plurality of images of the user. In some other instances, the camera 240 may capture a video composed of a plurality of frames, each of which may be understood to be an image of the user. Then the images may be transferred to the at least one control storage device 110 of the control system 100 to be processed by the at least one control processor 120 of the control system 100.

In some embodiments, the images may be processed by a machine learning (ML) model in runtime. As used herein, a ML model is a program that can find patterns or make decisions from a previously unseen dataset. For example, in face recognition, ML algorithms analyze and process facial features from images or videos, allowing the system to learn patterns and characteristics unique to each individual through training artificial neural networks. They can find features such as different parts of the face by matching these learned patterns against new facial data. The most common type of ML algorithm used for facial recognition is a deep learning Convolutional Neural Network (CNN). In some embodiments, user's head position and/or direction in the images may be used. In some other embodiments, the ML model may also detect the presence of a hand of the user and the hand gestures in the images.

In some embodiments, the ML model resides in the control storage device 110 of the control system 100, and can be performed by the control processor 120 of the control system 100 to process images captured by the camera 240. In some embodiments, the ML model process may include a pre-process stage, a main process stage, and a post-process stage. In the pre-process stage, each image may be cropped, resize, and formatted into appropriate color palette (e.g., RGB palette) to be passed on to the main process stage of the ML model. In some embodiments, the pre-process stage may also include normalizing the user image to certain range, for example the range [0, 1] that could be feasibly processed further by the ML model. In addition, the pre-process stage may also include adjusting the frame rate of the images to maintain a consistent input flow for the ML model, and/or any corrections needed to align the user's face in the images.

In some embodiments, the main process of ML model may include detecting user's state using a 3D mesh. In some embodiments, the user's state may be represented by the user's facial expression, the user's head movement, and the user's hand gesture. For example, the ML model may fit the 3D mesh to the user's face detected from each image captured by the camera 240, and generate a set of landmarks for characterizing the current state of the user. Different user state indicators, including facial expression indicators, head movement indicators, and hand gesture indicators, could be used to characterize the user's current states of whether the user has a facial expression, a hand gesture, and/or the user moves his/her head, etc. at a present time. To characterize the facial expression of the user, embodiments of the present disclosure consider using a set of facial expression indicators to characterize all detectable facial expressions of the user, such as smile, wink, eye squinting, etc. Each facial expression indicator may represent a particular facial expression of the user. For example, a facial expression indicator may be labeled as SMILE, which represents that the user is smiling. As another example, a facial expression indicator may be labeled as WINK, which represents that the user just winks. A facial expression indicator REGULAR may be used to represent the user's default or neutral facial expression. When the ML model detects a facial expression of the user, the ML model may output a corresponding facial expression indicator.

### Reaction Planning and Coordination

In various embodiments, the assistant system 400 has different interaction modes for the assistant device 200 to interact with the user in different manners and styles. For instance, the interaction modes may include gaming mode, mirroring mode, and the reversed-mirroring mode. The different interaction modes can be triggered or switched by user's verbal commands, sensor detections, or other appropriate means not limited by the present disclosure. Thereafter, once the interaction mode is determined, the reaction planning and coordination function within the control system 100 generates an appropriate command under that interaction mode to be sent to the assistant system 400. Under the mirroring and reversed-mirroring interaction modes, the command may contain a hand gesture indicator, a facial expression indicator, and a head movement indicator that indicates the user's hand gesture, the facial expression, and the head movement. Under the gaming interaction mode, the command may contain a hand gesture indicator, a facial expression indicator, and a head movement indicator that does not indicate the user's behaviors, but control the animated visual presentations (will be described below in detail) displayed on screen 230 of the assistant device 200 and the movement of the head of the assistant device 200. For example, while under gaming interaction mode for playing rock-paper-scissors with the user, the assistant system's play of rock, paper, and scissors is firstly decided randomly in response to user's play of rock, paper, and scissors. Then, the command including the hand gesture indicator that indicates the rock, paper, or scissors that is randomly decided is sent to the assistant system 400 to display the randomly-picked rock, paper, or scissors as a cartoon-styled hand component on the screen 230, thereby appearing to the user that the assistant device 200 is playing the game with him/her as a human-like companion. For another example, under the reversed-mirroring interaction mode, when the user is looking at the assistant device 200, the command that includes the head movement indicator that indicates the user's gaze direction toward the assistant device 200 would cause the assistant device 200 to change the display position of its facial component (e.g. a pair of eyes) on the screen 230 and/or cause physical movement of the head of the assistant device 200 so that the assistant device 200 may appear to look in a direction that is opposite to the user's gaze direction, thereby looking toward the user. More specifically, under the mirroring and the reversed-mirroring interaction modes, the facial expression indicator may be used by the assistant system 400 to generate a response to the facial expression of the user. The assistant system 400 may use the facial expression indicator to display an animated visual presentation on the screen 230 of the assistant device 200 to imitate the user's facial expression. This animated visual presentation on the screen 230 of the assistant device 200 may be interpreted by the user as the assistant device 200 is interacting with him/her. For example, when the user is smiling, the ML model may detect the user's facial expression of the smile and control system 100 outputs a facial expression indicator SMILE. The assistant system 400 may use the facial expression indicator SMILE to generate and display in real time an animated visual presentation of smile on the screen 230 of the assistant device 200, responding to the user's smile. The detail of the generation and display of the animated visual presentation will be described in detail below.

In some other embodiments, the assistant system 400 may also generate some other animated visual presentation for responding to the user's current state, which can be the user's facial expression, head movement, hand gestures, and any combination thereof. For example, the assistant system 400 may also generate and display an animated visual presentation of an accessory, such as a bow tie, a guitar, a coffee cup, a pair of sunglasses, etc., on the screen 230 of the assistant device 200, responding to the user's state. In some embodiments, the animated visual presentation for the facial expression and the animated visual presentation for the accessory may be displayed concurrently. In some embodiments, the animated visual presentation for the facial expression and the animated visual presentation for the accessory may be displayed separately and independently from each other.

To characterize the hand gesture of the user, embodiments of the present disclosure consider using a set of hand gesture indicators to characterize all detectable hand gestures of the user, such as hand waving, thumb up, thumb down, victory gesture, etc. Each hand gesture indicator may represent a particular hand gesture of the user. For example, a hand gesture indicator may be labeled as HAND_WAVE, which represents that the user is waving his/her hand in the image captured by the camera 240. When the ML model detects a hand gesture of the user in the images captured by the camera 240, the ML model may output a corresponding hand gesture indicator. Thereafter, the hand gesture indicator may be used by the assistant system 400 to generate a response to the hand gesture of the user. For example, the assistant system 400 may use the hand gesture indicator to display an animated visual presentation on the screen 230 of the assistant device 200 to imitate the user's hand gesture. The animated visual presentation on the screen 230 of the assistant device 200 may be interpreted by the user as the assistant device 200 is interacting with him/her. For example, when the user is waving his hand, the ML model may detect the hand waving and output a hand gesture indicator HAND_WAVE. The assistant system 400 may use the hand gesture indicator HAND_WAVE to generate and display in real time an animated visual presentation of hand waving on the screen 230 of the assistant device 200, responding to the user's hand waving.

To characterize the head movement of the user, embodiments of the present disclosure consider using a set of head movement indicators to characterize all detectable head movement of the user, such as head turning left, head turning right, head tilt, head up, and head down, etc. Each head movement indicator may represent a particular head movement of the user in the image captured by the camera 240. For example, a head movement indicator may be labeled as HEAD_TILT, which represents that the user is tilting his/her head aside. Once the ML model detects the head tilt, the control system 100 may output a corresponding head movement indicator. Thereafter, the head movement indicator may be used by the assistant system 400 to generate a response to the head movement of the user. For example, the assistant system 400 may use the head movement indicator to control the motors of the assistant device 200 through the motor controller 430 to imitate the user's head movement. The head movement of the assistant device 200 may be interpreted by the user as the assistant device 200 is interacting with him/her. For example, when the user is tilting his head, the ML model may detect the user's head tilt and output a head movement indicator HEAD_TILT. The assistant system 400 may use the head movement indicator HEAD_TILT to control the rotation of the motors of the assistant device 200 to tilt in real time the head 210 of the assistant device 200, responding to the user's head tilt. In some other embodiments, the assistant system 400 may also use the head movement indicator to display an animated visual presentation on the screen 230 to respond to the user's head movement. For example, when the user is tilting his head, the ML model may detect the user's head tilt and output a head movement indicator HEAD_TILT. The assistant system 400 may use the head movement indicator HEAD_TILT to display a pair of cartoon-styled eyes that are tilting aside on the screen 230 to respond to the user's head tilt.

In some embodiments, each of facial expression indicators, each of head movement indicators, and each of hand gesture indicators may be represented by a likelihood number normalized within the range [0, 1], the numeric value of which represents the extent of the user's facial expression, the extent of the user's head movement, or the hand gesture of the user. In some embodiments, different numeric value thresholds may be applied to each of the facial expression indicators, each of the head movement indicators, and each of hand gesture indicators. The control processor 120 may compare the numeric value representing a particular facial expression indicator output by the ML model with the corresponding numeric threshold applied for the particular facial expression indicator. Only when the numeric value representing the facial expression indicator, the numeric value representing the hand gesture indicator, or the numeric value representing the head movement indicator equals to or is greater than the numeric threshold applied for that particular facial expression indicator, the numeric threshold applied for that particular hand gesture indicator, the numeric threshold applied for that particular head movement indicator, respectively, the control processor 120 triggers a command to be sent to the assistant system 400 to instruct the assistant system 400 to respond to the user's facial expression, hand gesture, and head movements, for example, to display one or more animated visual presentations on the screen 230. For example, a numeric threshold applied for the facial expression indicator SMILE may be set as 0.5. A numeric value representing the particular facial expression indicator SMILE=0.7 may trigger the control processor 120 to send a command to the assistant system 400 to instruct the assistant system 400 to display an animated visual presentation of smile to respond to the user's facial expression smile on screen 230. Similarly, the control processor 120 may compare the numeric value representing a particular head movement indicator output by the ML model with the corresponding numeric threshold for the particular head movement indicator. Only when the numeric value representing the head movement indicator equals to or is greater than the numeric threshold, the control processor 120 triggers a command to be sent to the assistant system 400 to instruct the assistant system 400 to respond to the user's head movement, for example, to physically move the head 210 of the assistant device 200. For example, a numeric threshold for the head movement indicator HEAD_TILT may be set as 0.2. A numeric value representing a head movement indicator HEAD_TILT=0.3 may trigger the control processor 120 to send a command to the assistant system 400 to instruct the assistant system 400 to physically move the head 210 of the assistant device 200 to represent that the user is tilting his/her head. In some other embodiments, the assistant system 400 may also display an animated visual presentation to respond to the user's head movement without physically moving the head 210 of the assistant device 200. For example, once the user's head tilt is detected by the control system 100 and a command is sent to the assistant system 400, the assistant system 400 may display on the screen 230 a pair of carton-styled eyes that are tilted aside to imitate the head tilt of the user. As another example, once the user's head movement to the left is detected by the control system and a command is sent to the assistant system 400, the assistant system 400 may display on the screen 230 a pair of cartoon-styled eyes that are moved to the left of the screen 230 to imitate the head movement of the user.

Application of thresholds to user state indicators, such as the facial expression indicators, head movement indicators, and hand gesture indicators, provides many benefits. For example, the assistant device 200 may respond only when the user actually has a facial expression, or moves his head to certain extent. For example, if the user smiles just a bit, the assistant device 200 will not be triggered to respond. In this way, the assistant device 200 will not overreact. In addition, once the assistant device 200 is triggered to respond to the user's facial expression or head movement, the assistant device's expression or movement will be accurately triggered so that the assistant device's display does not change unnecessarily, or the assistant device's head does not move unnecessarily. In this way, the assistant device may remain “mentally stable” or “emotionally stable.”

In some embodiments, tracking may be performed over each of the set of facial expression indicators, each of the set of head movement indicators, and each of the set of hand gesture indicators. In some embodiments, the control processor 120 may track the change of each of the set of facial expression indicators, each of the set head movement indicators, and each of the hand gesture indicators via filtering over time with methods such as averaging, Kalman filtering, etc. Only when the changes in the numeric value representing the facial expression indicator, the head movement indicator, or the hand gesture indicator is greater than a numeric threshold applied for that facial expression indicator, head movement indicator, or the hand gesture indicator, the control processor 120 triggers the planning and coordination function to generate a response based on the user's state and the response is sent as a command to the assistant system 400 to instruct the assistant system 400 to display one or more animated visual presentations in reaction to the user's state. In other words, only when the changes in the numeric value representing the user's facial expression, hand gesture, and/or head movement is sufficiently obvious, the assistant device 200 responds to the user's behaviors. Otherwise, the assistant device 200 does not provide response in reaction to the user's behaviors. In some aspects, the assistant device 200 does not provide response by remaining or returning to its idle state. In some other aspects, the assistant device 200 does not provide response by keeping displaying the same animated visual presentation of the facial component on the screen 230 without any changes to another animated visual presentation. Tracking the user state indicators provides many benefits. For example, tracking the user state indicators may help with efficiency and latency requirements of the ML model processing as unnecessary computation is avoided when no significant facial expression or head movement is present.

### Assistant System Process Flow

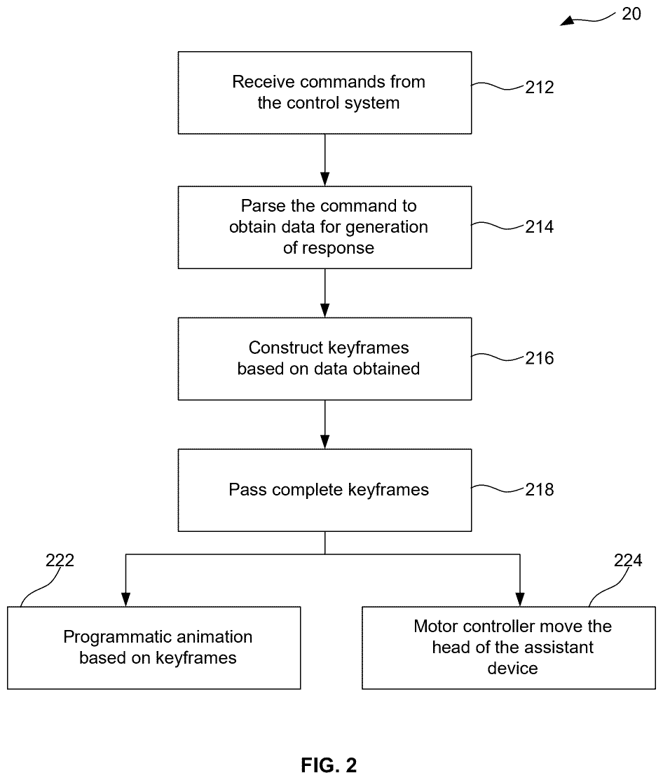

As described above, the assistant system 400 may receive commands sent from the control system 100 to provide real-time responses in reaction to the user's state. The response is generated by the planning and coordination function in different manners depending on the interaction modes of the assistant system 400. For instance, under the mirroring and the reversed-mirroring interaction modes, the response may be mirrored or reversed-mirrored response, respectively, and it includes displaying an animated visual presentation and/or causing a physical movement of the head 210 of the assistant device 200 to imitate the current facial expression of the user, the current hand gesture of the user, the current head movement of the user, or any combination thereof. In some instances, under the mirroring interaction mode, the animated visual presentation displayed on the screen 230 exactly imitates the user's facial expression, and/or the physical movement of the head 210 of the assistant device 200 exactly imitates the user's head movement. For example, if the user winks or blinks with his/her right eye closed, the animated visual presentation displayed on the screen 230 may include a pair of cartoon-styled eyes with the right eye closed. As another example, if the user turns his/her head to the left, the head 210 of the assistant device 200 may be turned to the left. In some instances, under the reversed-mirroring interaction modes, the animated visual presentation displayed on the screen 230 is a mirror image of the user's facial expression, or the physical movement of the head 210 of the assistant device 200 mirrors the user's head movement. For example, if the user winks or blinks with his/her right eye closed, the animated visual presentation displayed on the screen 230 may include a pair of cartoon-styled eyes with the left eye closed. As another example, if the user turns his/her head to the left, the head 210 of the assistant device 200 may be turned to the right. To realize the mirroring or reversed-mirroring interaction mode, each of the pair of cartoon-styled eyes may be independently controlled according to the mirroring or reversed-mirroring interaction mode. In another example, under the gaming interaction mode, the response may be a non-mirrored response (i.e., not imitating) in reaction to the user's state, so as the response includes displaying an animated visual presentation and/or causing a physical movement of the head 210 of the assistant device 200 that is/are different than the user's current facial expression, the current hand gesture of the user, and/or the user's head movement. For instance, when the user is playing a dynamic game involving different hand gestures, the assistant device 200 may play a hand gesture that is different than the hand gesture played by the user, so that the user and the assistant device 200 can play the game as two opponents, with user winning, losing, or the game ending in a tie. Such non-mirrored response enables the assistant device 200 to interact responsively with the user rather than merely imitating the user, thereby providing the user with a more natural and realistic interaction experience. According to some embodiments, an overview of the process performed by assistant system 400 to provide a real-time response to the user's state, including facial expression, head movement, and hand gesture, is described with reference to the process flow 20 shown in FIG. 2.

At stage 212, the assistant system 400 receives commands sent from the control system 100 to provide a response to the user's current state. In some embodiments, the command may contain the facial expression indicator, which characterizes the current facial expression of the user. For example, the command may contain facial expression indicator SMILE. In some embodiments, the command may contain the head movement indicator, which characterizes the current head movement of the user. For example, the command may contain head movement indicator HEAD_TILT. In some other embodiments, the command may also contain the hand gesture indicator, which characterizes the current hand gesture of the user. For example, the command may contain the hand gesture indicator HAND_WAVE. In some other embodiments, it is considered that the control system 100 may transmit multiple user state indicators in one command. In such case, a command may contain multiple data fields. One or more data fields may contain the facial expression indicator, one or more data fields may contain the head movement gesture, and one or more data fields may contain the hand gesture indicator. In this case, a command could be used to convey all user state indicators. For example, the command may contain in different data fields facial expression indicator SMILE, head movement indicator HEAD_TILT, and hand gesture indicator HAND_WAVE, which could be understood as the user is now smiling, with his/her head tilted and hand is waving.

In some embodiments, at stage 214, the assistant processor 420 of the assistant system 400 may parse the command and obtain data for generation of a response. Specifically, the assistant processor 420 of the assistant system 400 may parse the command to obtain the facial expression indicator, such as SMILE, to obtain the head movement indicator, such as HEAD_TILT, and/or to obtain the hand gesture indicator, such as HAND_WAVE.

In some embodiments, at stage 216, the assistant processor 420 of the assistant system 400 may construct a keyframe based on the data obtained. Specifically, the assistant processor 420 of the assistant system 400 may construct a keyframe based on the facial expression indicator and/or the hand gesture indicator. The details of the construction of the keyframe will be described in detail below. As a plurality of images of the user captured by the camera 240 are processed, the construction of keyframe may be repeated to construct a plurality of keyframes.

In some embodiments, at stage 218, the complete keyframes may be passed to an animation engine operating in the assistant processor 420 of the assistant system 400 to programmatically generate one or more animated visual presentations based on the keyframes. It should be noted that, as used herein, the animation engine may refer to a software package running in the assistant processor 420 that carries out a series of instructions to generate one or more animated visual presentations based on the plurality of keyframes and to display the generated one or more animated visual presentations on the screen 230 of the assistant device. It should also be noted that the present disclosure is not limited to specific animation engines.

In some embodiments, at stage 222, programmatic animation may be performed in the assistant processor 420 of the assistant system 400, such as by the animation engine, to form one or more animated visual presentations based on the keyframes. Then, the assistant processor 420 of the 400 may display the one or more animated visual presentations on the screen 230 of the assistant device 200. The programmatic animation will be described in detail below.

In some embodiments, at stage 224, the assistant processor 420 of the assistant system 400 may generate a motion vector based on the head movement indicator contained in the command received at stage 212. Then, the assistant processor 420 of the assistant system 400 may dispatch the motion vector to the motor controller 430, which controls the rotation of motors mounted on the assistant device 200. In some embodiments, the rotation of the motors may rotate the head 210 of the assistant device 200 to respond to the current head movement of the user. The movement control of the head 210 of the assistant device 200 will be described in detail below.

### Generation and Display of the Animated Visual Presentations

Some embodiments of the present disclosure propose dynamically generating animated visual presentations as real-time responses in reaction to the user's facial expression(s) and hand gesture(s). To enhance human-machine interactions for a user, traditional animation includes the creation of each explicit frame of an animation sequence. These frames are created and stored before the animation needs to be shown. The animation must be played at the chosen frame rate for it to be displayed properly. Any deviation causes frames to skip or stagger. Unlike the traditional animation, each of the animated visual presentations displayed on the screen 230 of the assistant device 200 as described in the present disclosure may be generated by programmatic animation based on a plurality of keyframes. Each keyframe may have various virtual components and each of the virtual components may be animated separately and independently so that one or more virtual components may change over a certain period time while other one or more virtual components may remain unchanged over the same period of time. As discussed with reference to stage 222 of FIG. 2, the plurality of keyframes could be interpolated to generate transitional frames between adjacent keyframes. Because of programmatic animation, the transitional frames may be rendered at any discrete time by the assistant processor 420 of the assistant system 400 in some embodiments. In some aspects, the programmatic animation allows the one or more animated visual presentations to be shown at any selected frame rate without losing animation quality. Thus, the animated visual presentations generated by the programmatic animation provides a smoother approach than traditional pre-rendered animation frames and allows for more control of the animation during runtime.

The construction of a keyframe, as illustrated at stage 216 of process flow 20 performed by the assistant system 400, is further described in detail. As the first step of animation, a keyframe is constructed. A keyframe is an absolute data point within an animation sequence at a particular time. Each keyframe represents a visual presentation that corresponds to the user's current state and the animation of a plurality of keyframes form the animated visual presentation that is displayed on the screen of the assistant device. In some embodiments, a keyframe may contain only a facial component used as a response to the facial expression of the user. In some aspects, the facial component in the keyframe may imitate the current facial expression of the user (i.e., mirrored response) or may be different than but associated with the current facial expression of the user (i.e., non-mirrored response). In some embodiments, the keyframe may contain the facial component and a hand component used to represent the hand gesture of the user if the user's hand(s) is/are shown in the image captured by the camera 240 and the user is making a particular hand gesture, such as hand waving. The hand component in the keyframe may imitate the current hand gesture of the user or may be different than but associated with the hand gesture of the user. For example, in the gaming mode, the hand component of the keyframe may represent that the assistant device 200 is playing gaming with the user. In some embodiments, the keyframe may contain the facial component and an accessory component as a response to the user's current facial expressions and hand gestures. In some other embodiments, the keyframe may contain the facial component, the hand component, and the accessory component as a response. In some other embodiments, the keyframes may contain the facial component and other types of virtual components, such as a background component, or different combinations of different types of virtual components as a response to the user's current facial expressions and hand gestures. The accessory component and the background component may be static or non-static images (ex. animated GIFs) to provide vivid context or effects to enhance appearance and visual appeal. In some embodiments, a keyframe of an animated visual presentation displayed on the screen 230 of the assistant device 200 may include different types of virtual components on different layers for separate and independent animation of the various types of virtual components. As such, the instant change in user's facial expression, hand gesture, head movement, or the overall combination may be isolated to just the face, hand, head, or any combination of the face, hand, and head, and the corresponding change in the facial component, the hand component, the accessory component, the background component, or any combination thereof may construct a keyframe as a visual presentation specific for the isolated change of the user. For instance, when the user is holding a hand gesture while his/her facial expression changes from a first facial expression to a second facial expression, the assistant system 400 would understand that change happens in the facial expression only, and displays an animated visual presentation where the facial component updates from a first facial component corresponding to the user's first facial expression to a second facial component corresponding to the user's second facial expression, while the hand component remains the same. In this way, the subject matter disclosed herein provides an animated visual presentation where the assistant system 400 causes changes in animated visual presentations as how the user changes, thereby bringing an enhanced real-time interactions between the assistant device 200 and the user.

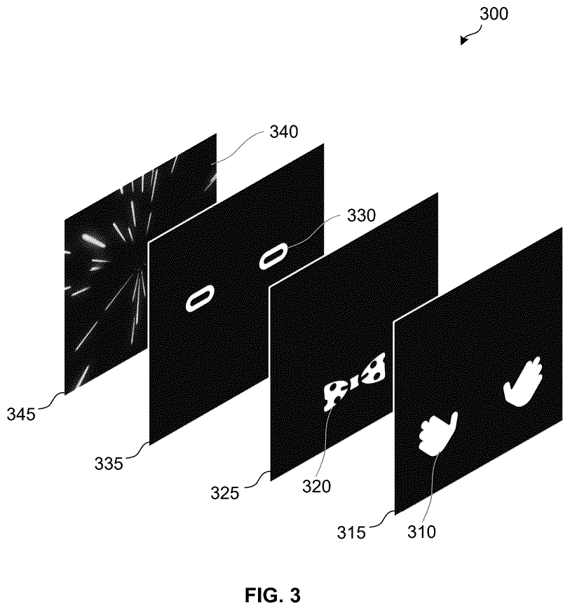

FIG. 3 shows an example of a keyframe of an animated visual presentation. The keyframe may have multiple layers and contain various types of virtual components on different layers. As illustrated in FIG. 3, the keyframe 300 may include a hand component 310 on the first layer 315, an accessory component 320 on the second layer 325, a facial component 330 on the third layer 335, and a background component 340 on the fourth layer 345. The various types of virtual components are also placed at different locations in the keyframe. For the example of FIG. 3, the composition of the keyframe 300 has the hand component 310 placed in the lower half region, the accessory component 320 placed in the lower half region but visually separate from the hand component 310, and the facial component 330 placed approximately at the center of the keyframe. The keyframe 300 may have other compositions to place the virtual components at spots different from the composition shown in FIG. 3, so long as the virtual components that are shown on the screen 230 do not overlap with each other and can all be displayed on the screen 230. As described below in detail, the hand component 310, accessory component 320, facial component 330, and background component 340 are selected from a set of hand elements, a set of accessory elements, a set of facial elements, and a set of background elements, respectively. Each element is associated with a set of display parameters including the position and rotation of the element on the screen 230 of the assistant device 200. The assistant processor 420 of the assistant system 400 may control and adjust the display of the virtual components according to the set of display parameters associated with the correlating elements. Continuing with the description of FIG. 3, a hand element of a pair of open hands, an accessory element of a bowtie, a facial element of a pair of eyes in an ellipse shape, and a background element of lightning strikes are selected to be included in the visual presentation as the hand component 310, the accessory component 320, the facial component 330, and the background component 340, respectively. Similarly, the visual presentation may contain other cartoon-styled features for the hand component 310, the accessory component 320, and the background component 340. In some embodiments, the keyframe may only have the facial component 330. In some other embodiments, the keyframe may have the facial component 330 and other virtual components. It should be noted that the embodiments of the present disclosure are not limited to the specific order, the number of the layers, or the number of different types of virtual components on a same layer as shown in FIG. 3.

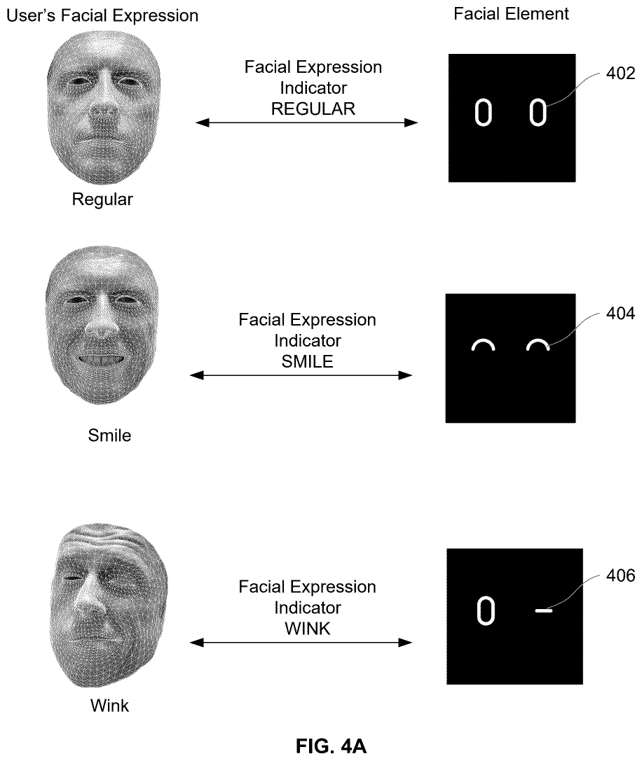

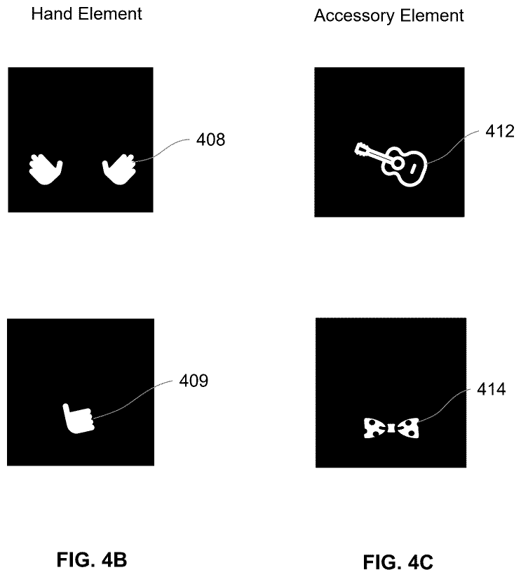

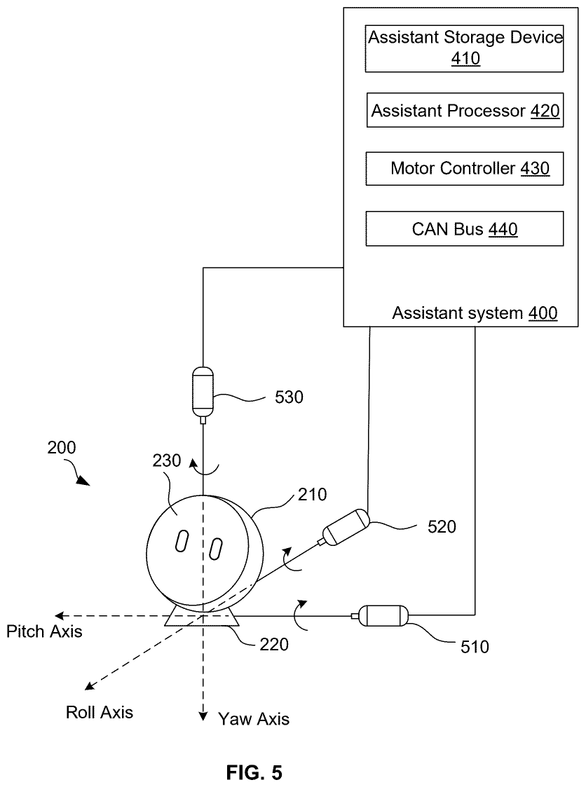

In some embodiments, the keyframe shown in FIG. 3 may be constructed according to the command received by the assistant system 400. As described above, the command received by the assistant system 400 may contain a facial expression indicator, a hand gesture indicator, and/or a head movement indicator. The assistant processor 420 of the assistant system 400 may parse the command to obtain the facial expression indicator, the hand gesture indicator, and/or the head movement indicator. In some embodiments, the facial component 330 may be generated according to the facial expression indicator. To characterize the user's facial expression, a set of facial elements are constructed using splines and are stored in a database in the assistant storage device 410 of the assistant system 400. Each facial element correlates to a particular facial expression indicator. As described above, a set of facial expression indicators are provided to characterize all detectable facial expressions of the user. Thus, the set of facial elements may be used to characterize all detectable facial expression of the user. Based on the facial expression indicator, the assistant processor 420 may determine a particular facial element from the set of facial elements that correlates to the facial expression indicator to represent the current facial expression of the user (as shown in FIG. 4A).

In some embodiments, a facial element may be constructed using a spline, such as, a Bezer spline. Usually, a spline may be segmented into any number of points, each with information pertaining to the curvature of the line coming into and going out of that point. As is known in the field, varieties of mathematical formulas could be used to create different spline shapes that could be used as the facial elements. FIG. 4A shows some examples of the facial elements according to some embodiments of the present disclosure. For the example of FIG. 4A, the facial elements may be a pair of cartoon-styled eyes that could be used as the facial component 330 shown on the screen 230 of the assistant device 200. In various aspects, each eye has a geometrical shape. The movement of each eye may be separately constructed by controlling the number of points on the geometrical shape. By adjusting the number of points and their associated properties, each eye may change into variety of shapes, thereby providing separate animation of each eye in the facial component 330.

As shown in FIG. 4A, the facial element 402 correlates to the facial expression indicator REGULAR, the facial element 404 correlates to the facial expression indicator SMILE, and the facial element 406 correlates to the facial expression indicator WINK. As described above, a facial expression indicator represents a particular facial expression of the user at the present time. Thus, the facial element 402 corresponds to the user's neutral facial expression and indicates that the user currently has a neutral facial expression, the facial element 404 corresponds to the user's facial expression smile and indicates that the user is currently smiling, and the facial element 406 corresponds to the user's facial expression wink and indicates that the user just winked. The assistant processor 420 of the assistant system 400 may use a particular facial element correlated with the facial expression indicator contained in the received command to generate the facial component 330 to be included in the keyframe 300. For example, the assistant processor 420 of the assistant system 400 may use facial element 404 to generate the facial component 330 to be included in the keyframe 300 to imitate the user's facial expression smile when the command received by the assistant system 400 contain the facial expression indicator SMILE. In some embodiments, the facial component 330 is always displayed on the screen 230 of the assistant device 200. In some embodiments, each facial element 402, 404, and 406 is associated with a set of display parameters including the position and rotation of the facial element on the screen 230 of the assistant device 200. The assistant processor 420 of the assistant system 400 may control and adjust the display of the facial component 330 according to the set of display parameters associated with the facial element. For example, in the coordinate system [x, y] established for displaying the animated visual presentation on the screen 230 of the assistant device 200, the lower left corner of the screen 230 may be defined as the original point [0, 0], and the screen 230 may include a 240×240 display area. The position of the facial element displayed on the screen 230 may have the center of the facial element being at coordinates [120, 120] in order to display the facial element, such as the facial element 402, 404, or 406 as the facial component 330 at the center of the screen 230. The rotation of the facial element may be 0° with respect to the horizontal line in order to display the facial element 402, 404, or 406 horizontally. In this way, when the user smiles and then does a wink, a first keyframe containing the facial element 404 horizontally positioned at coordinates [120, 120] as the facial component 330 and a second keyframe containing the horizontally positioned facial element 406 horizontally positioned at coordinates [120, 120] as the facial component 330 are generated based on commands received by the assistant system 400 and the animation engine creates an animated visual presentation that shows a transition from the first keyframe to the second keyframe. The created animated visual presentation of facial component 330 is then displayed on the screen 230 of the assistant device 200 to show the change of the pair of eyes at the same position as a response in reaction to the change in user's facial expression. For another example, the position of the facial element displayed on the screen 230 may have the center of the facial element being at other coordinates, the facial element having a rotation with respect to the horizontal line, or a combination thereof in order to display the facial element 402, 404, or 406 at a different position with or without an angle on the screen 230 in reaction to the user's facial expressions. In this way, when the user does other facial expressions such as shifting his/her eyes, tilting the head (as described above, may be responded via animated visual presentation), a first keyframe containing the facial element (not shown), correlating to a first facial expression indicator, positioned at a first coordinates as the facial component 330 and a second keyframe containing the facial element (not shown), correlating to a second facial expression indicator, diagonally positioned at a second coordinates as the facial component 330 are generated based on commands received by the assistant system 400 and the animation engine creates an animated visual presentation that shows a transition from the first keyframe to the second keyframe. The created animated visual presentation of facial component 330 is then displayed on the screen 230 of the assistant device 200 to show the movement in addition to the change of the pair of eyes as a response in reaction to the user's change. For various aspects, the facial component 330 represents cartoon-styled expressions in reaction to the user's facial expressions during the user's interactions with the assistant device 200, so as to make the user interprets such displayed cartoon-styled expressions as vivid responses provided by the assistant device 200 in real-time as if the assistant device 200 is a human-like companion. It should be understood that the facial expression indicators are not limited to REGULAR, SMILE, and WINK only and the facial elements are not limited to those as shown in FIG. 4A. The subject matter disclosed herein can have the pair of eyes in other shapes (e.g. as shown in FIG. 3) as the facial component 330 in the visual presentation displayed on the screen 230 of the assistant device 200.

In some embodiments, the hand component 310 of the keyframe 300 shown in FIG. 3 may be constructed using an image. Similar to the facial component 330, the hand component 310 may be generated according to the command received by the assistant system 400. The assistant processor 420 of the assistant system 400 may parse the command received from the control system 100 and obtain the hand gesture indicator. Then, the assistant processor 420 of the assistant system 400 may generate the hand component 310 according to the hand gesture indicator. To characterize the user's hand gestures, a set of hand elements are stored in a database in the assistant storage device 410 of the assistant system 400. Each hand element correlates to a particular hand gesture indicator. Based on the hand gesture indicator, the assistant processor 420 may determine a particular facial element from the set of hand elements that correlates to the hand gesture indicator to represent the current hand gesture of the user.

FIG. 4B shows some examples of the hand elements according to some embodiments of the present disclosure. As shown, the hand elements may be a pair of cartoon-styled hands as the hand component 310 shown on the screen 230 of the assistant device 200. In some embodiments, the hand element 408 correlates to the hand gesture indicator HAND_WAVE and indicates that the user is currently waving or just waved at the assistant device 200, the hand element 409 correlates to the hand gesture indicator THUMB_UP and indicates that the user is currently holding a thumb up or just gave the assistant device 200 a thumb-up. As described above, a hand gesture indicator represents the user's hand gesture at the present time. Thus, the hand element 408 corresponds to the user's waving hand, and the hand element 409 corresponds to the user's thumb-up gesture. The assistant processor 420 of the assistant system 400 may use a particular hand element correlated with the hand gesture indicator contained in the received command to generate the hand component 310 of the keyframe 300. For example, the assistant processor 420 of the assistant system 400 may use hand element 408 to generate the hand component 310 of the keyframe 300 to imitate the user's waving hand when the command received by the assistant system 400 contains the hand gesture indicator HAND_WAVE. In some embodiments, each hand element 408 and 409 is associated with a set of display parameters including the position and rotation of the hand element on the screen 230 of the assistant device 200. The assistant processor 420 of the assistant system 400 may control and adjust the display of the hand component 310 according to the set of display parameters associated with the hand element. For example, in the coordinate system [x, y] established for displaying the animated visual presentation on the screen 230 of the assistant device 200, the lower left corner of the screen 230 may be defined as the original point [0, 0], and the screen 230 may include a 240×240 display area. The position of the hand element displayed on the screen 230 may be at coordinates [120, 80] in order to display hand element, such as the hand element 408 or 409 as the hand component 310 at the center of the screen 230 and lower than the facial component 330 displayed the screen 230. In this way, the hand component 310 does not overlap with the facial component 330 displayed on the screen 230. For example, the rotation of the hand element may be 0° in order to display the hand element 409 horizontally. As another example, the rotation of the hand element may be within [−15°, 15°] for the hand element 409. For the hand element 408 that shows a pair of waving hands, the rotation of the hand element may be for one hand to rotate within [−15°, 15°] and the other hand to rotate within [15°, −15°]. In other words, the two hands rotate in opposite directions to imitate a pair of waving hands. The animation of the keyframes, which include the cartoon-styled hand component, forms an animated visual presentation displayed on screen 230 of the assistant device 200. The animated visual presentation shows the rotating hand component, and it may be interpreted by the user who is interacting with the assistant device 200 as a gesture performed by the assistant device 200 in reaction to the gesture performed by the user. For instance, when the user is waving or just waved his/her hands at the assistant device 200, the animated visual presentation of the hand component displayed on the screen 230 may cause the user to believe that the assistant device 200 is waving back at the user.

In some aspects, the responsive facial expressions or the responsive hand gestures may be imitations of the facial expressions and body languages of the user. In some other aspects, the responsive facial expressions or the hand gestures may be different but logically related to those of the user so that the user understands the assistant device 200 is interacting with the user via the displayed facial component 330 and the hand component 310.

In some embodiments, the accessory component 320 of the keyframe 300 may be generated using an image. In some embodiments, for generating the accessory component 320, a set of accessory elements could be stored in a database in the assistant storage device 410 of the assistant system 400. The assistant processor 420 of the assistant system 400 may determine a particular accessory element from the set of accessory elements to generate the accessory component 320. In some embodiments, some of the set of accessory elements may include static images. In some other embodiments, some of the set of accessory elements may include changing images (animated GIFs, animated sprite, etc.), so that the accessory component 320 using a changing image may display changes to its own image during animation performed at stage 222 shown in FIG. 2. FIG. 4C shows some examples of the accessory elements. As shown in FIG. 4C, accessory element 412 may be a cartoon-styled guitar, and the accessory element 414 may be a cartoon-styled bow tie. Separate from the facial component 330 and the hand component 310, the accessory component 320 could be independently generated. In some embodiments, only one accessory component 320 could be displayed on the screen 230 of the assistant device 200 at a time, so that a previous accessory component 320 is removed when a new accessory component 320 is entering. In some embodiments, each accessory element is associated with a set of display parameters including position, rotation, time to enter, and time to leave. The assistant processor 420 of the assistant system 400 may control and adjust the display of the accessory component 320 according to the set of display parameters associated with the accessory elements. For example, in the coordinate system [x, y] established for displaying the animated visual presentation on the screen 230 of the assistant device 200, the lower left corner of the screen 230 may be defined as the original point [0, 0], and the screen 230 may include a 240×240 display area. The position of the accessory element displayed on the screen 230 may be at coordinates [100, 80] in order to display selected accessory element, such as the accessory element 412 or 414 as the accessory component 320 at the lower left part of the screen 230. In this way, the accessory component 320 does not overlap with the facial component 330 displayed on the screen 230. For example, the rotation of the hand element may be 0° in order to display the accessory element 412 or 414 horizontally. As another example, the rotation of the accessory element may be within [−15°, 15°] for the accessory element 412 or 414. As one example, time to enter may be set to 0 to indicate that the selected accessory element, such as accessory element 412 or 414, is displayed immediately without delay. As one example, the time to leave may be set to 3 seconds to indicate that the selected accessory element may exit the screen 230 after displaying for 3 seconds.

Similar to the accessory component 320, the background component 340 of the keyframe 300 may be generated using an image. In some embodiments, for the background component 340, a set of background elements could be stored in a database in the assistant storage device 410 of the assistant system 400. The assistant processor 420 of the assistant system 400 may determine a particular background element from the set of background elements to generate the background component 340. In some embodiments, some of the set of background elements may include static images. In some other embodiments, some of the set of background elements may include changing images (animated GIFs, animated sprite, etc.), so that the background component 340 generated using a changing image may display changes to its own image during animation performed at stage 222 shown in FIG. 2. In some embodiments, the background component 340 could be independently generated. In some embodiments, each background element is associated with a set of display parameters including position, rotation, time to display, and time to exit. The assistant processor 420 of the assistant system may control and adjust the display of the background component 340 according to the set of display parameters associated with the background element. For example, in the coordinate system [x, y] established for displaying the animated visual presentation on the screen 230 of the assistant device 200, the lower left corner of the screen 230 may be defined as the original point [0, 0], and the screen 230 may include a 240×240 display area. The position of the background element displayed on the screen 230 may be at coordinates [240, 240] in order to display the selected background element as the background component 340 over the whole area of the screen 230. For example, the rotation of the hand element may be 0° in order to display the selected background element horizontally. As one example, time to display may be set to 0 to indicate that the selected background element is displayed immediately without delay. As one example, the time to leave may be set to 3 seconds to indicate that the selected background element may exit the screen 230 after displaying for 3 seconds. As one example, the background component 340 shown in FIG. 3 includes an image of lighting strikes. In some other embodiments, the background component 340 may also contain or being animated to contain other cartoon-styled features.

According to the above description, a keyframe may be constructed at stage 216 of the process flow 20 shown in FIG. 2. For the example of FIG. 3, the facial component 330 contains a pair of cartoon-styled eyes of the assistant device 200, the hand component 310 contains a pair of waving hands, the accessory component 320 contains a bow tie, and the background component 340 involves lighting strikes as if the assistant device 200 is a human-like companion with a pair of eyes while wearing a bow tie and waving his/her hands in the lighting strikes. Keyframes constructed according to some embodiments may provide a smoother approach than traditional pre-rendered animation frames and allow for more dynamic control of the animation during runtime.

Based on the commands received from the control system 100, the assistant processor 420 of the assistant system 400 may repeat the keyframe construction process above to construct a plurality of keyframes. These keyframes are passed to the assistant processor 420 at stage 218 of process flow 20, shown in FIG. 2. Then the assistant system 400 may perform programmatic animation based on these keyframes to form one or more animated visual presentations at stage 222 of the process flow 20 shown in FIG. 2. In some embodiments, the assistant system 400 may interpolate one keyframe to another based on the passage of time to form transitional frames. In some embodiments, the interpolation may be performed at any frame rate determined according to particular applications. Unlike the traditional pre-rendered animation, such interpolation of the keyframes allows more control of the animation during runtime. Then, the keyframes and the transitional frames may form the one or more animated visual presentations to be displayed on the screen 230 of the assistant device 200. As the state of the user changes, such as the facial expression, head movement, and/or hand gesture changes, the interpolation of the keyframes can be used to show transition between keyframes as a response in reaction to such change from the first state to the second state. The one or more animated visual presentations displayed on the screen 230 of the assistant device 200 may be interpreted by the user as the assistant device 200 is interacting with him/her, providing the user with a human-companion-like experience.

### Movement Control of the Assistant Device

Some embodiments of the present disclosure may cause physical motion of the assistant device 200 to provide a response in reaction to the user's state. For example, when the user is looking at the assistant device 200, the screen 230 of the assistant device 200 may be turned towards the user. In some embodiments, the assistant system 400 may dynamically control the movement of the head 210 of the assistant device 200 based on commands received from the control system 100. As described above, the command received from the control system 100 may contain a head movement indicator. The assistant processor 420 of the assistant system 400 may control the rotation of motors mounted on the assistant device 200 to make the head 210 of the assistant device 200 move to a particular position with respect to the base 220 in reaction to the user's head movement in the yaw, pitch, and/or roll directions. For example, the command received by the assistant processor 420 contains a head movement indicator HEAD_PITCH, which means that the user is moving his/her head in the pitch direction, like raising or lowering the head as slow-motion nodding. The assistant processor 420 of the assistant system 400 may control the rotation of the motors mounted on the assistant device 200 to make the head 210 of the assistant to raise or lower, imitating the user's head movement. The movement control of the head 210 of the assistant device will be described in detail with reference to FIG. 5.

FIG. 5 shows a schematic diagram of the assistant device 200 according to some embodiments of the present disclosure. As illustrated, the assistant device 200 may include three motors 510, 520, and 530 to control rotations of the head 210 of the assistant device 200 around pitch, roll, and yaw axis. Specifically, the motor 510 may rotate the head 210 of the assistant device 200 around the pitch axis, i.e. pitching, the motor 520 may rotate the head 210 of the assistant device 200 around the roll axis, i.e. rolling, and the motor 530 may rotate the head 210 of the assistant device 200 around the yaw axis, i.e. yawing. In some embodiments, the assistant processor 420 of the assistant system 400 may control the rotation of respective motors 510-530 through the motor controller 430 shown in FIG. 1. A motion vector including rotation angles of the motors 510-530, represented by [pitch angle, roll angle, yaw angle] may be used by the assistant processor 420 for controlling the rotation of motors 510-530. In some embodiments, the idle state of the head 210 of the assistant device 200 may be represented by the motion vector [0, 0, 0], which means the head 210 is in a vertical position with the screen 230 of the assistant device 200 facing straight ahead. In some embodiments, a set of motion vectors are stored in the assistant storage device 410 of the assistant system 400. Each motion vector correlates to a particular head movement indicator. As described above, a set of head movement indicators are provided to characterize all detectable head movements of the user. Thus, the set of motion vectors may be used to characterize all detectable head movements of the user. For example, a head movement indicator HEAD_ROLL may correlate to a particular motion vector [0, 15, 0]. The assistant processor 420 of the assistant system 400 may control, through the motor controller 430, the motor 520 to rotate by 15° to cause the head 210 of the assistant device to roll aside. By controlling one or more of the motors 510-530, the head 210 of assistant device 200 may cause its face, i.e., the screen 230, to rotate in any direction during the display of one or more animated visual presentations on the screen 230 of the assistant device 200. The physical movement of the head 210 of the assistant device 200 may be interpreted by the user as the assistant device 200 is interacting with him/her and thus provides the user with a human-companion-like experience. For example, when the user is smiling, turning his or her head to the assistant device 200, and looking at the assistant device 200, an animated visual presentation representing smiling is displayed on the screen 230 of the assistant device 200 according to the above description, and the head 210 of the assistant device 200 may be rotated to orient the screen 230 to face the direction of the user. As the user turns his/her head away, the head 210 of the assistant device 200 may be rotated back to its idle state.

In some other embodiments, the assistant system 400 may interact with the user under the gaming interaction mode, which can be triggered by user's verbal commands, sensor detections, or other appropriate means not limited by the present disclosure. For example, the assistant system 400 may play a rock-paper-scissors game with the user under the gaming interaction mode. Under the gaming interaction mode, the assistant system 400 may display an animated visual presentation representing a gaming hand gesture, such as rock, paper, or scissors. As one example, the set of hand elements may include cartoon-styled hand gesture images of rock, paper, and scissors. The hand component 310 of the keyframe 300 may be generated using randomly selected one of the cartoon-style hand gesture images of rock, paper, or scissors. For example, the hand component 310 of the keyframe 300 may be generated using the cartoon-styled hand gesture image of rock. Then the animated visual presentation generated based on the keyframe 300 could be displayed on the screen 230 to indicate that the assistant device 200 is playing the game with the user and holding a rock gesture.

The control system 100 may detect the user's hand gesture within a predetermined time period, such as 5 seconds. Once the user's hand gesture is detected, the control system 100 may determine and output a hand gesture indicator. For example, if the user holds a hand gesture of paper, the control system 100 may detect the user's hand gesture of paper and determine a hand gesture indicator HAND_PAPER. As discussed above, a command may be sent by the control system 100 to the assistant system 400, and the command includes the hand gesture indicator HAND_PAPER. Upon receiving the command, the assistant system 400 may parse the command to obtain the hand gesture indicator HAND_PAPER. After comparing the hand gesture indicator obtained from the received command with the hand element selected by the assistant system 400, the assistant system 400 may determine the game result. For example, as the assistant system 400 selected the hand element of rock, and the hand gesture indicator HAND_PAPER obtained from the received command represents the user's hand gesture of paper, the assistant system 400 may determine that the user wins in this round of the game. In some embodiments, the assistant system 400 may play an animated visual presentation representing the game result on the screen 230. For example, the assistant system 400 may construct the keyframe 300 including the hand component 310, where the hand component 310 is generated using a hand element 409 of thumb up (shown in FIG. 4B) selected from the set of hand elements stored in the assistant storage device 410. Then, the assistant system 400 may generate an animated visual presentation displayed on the screen 230, showing a thumb up to indicate that the user wins this round. The game may repeat for one or more rounds. For example, as the assistant system 400 is triggered to enter the gaming interaction mode, the assistant system 400 may start a counter, which may count down from 3 to 0 after a round of the game. After three rounds of the game, the assistant system 400 may display an animated visual presentation representing the final result of the game on the screen.

### Method Flow

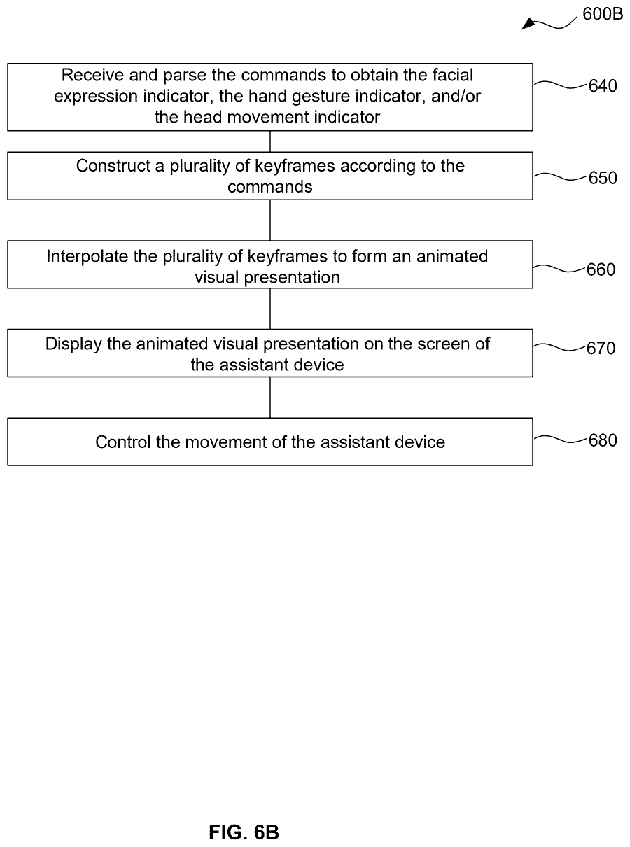

In an aspect of the present disclosure, a method for in-vehicle interaction is proposed. FIGS. 6A and 6B show flow charts of the method 600A and method 600B for in-vehicle interaction according to some embodiments of the present disclosure. It should be noted that the methods 600A and 600B may be performed on the vehicle environment shown in FIG. 1. Thus, the above descriptions with reference to FIGS. 1-5 may equally apply in the methods 600A and 600B, and the methods 600A and 600B will be described according to the above descriptions. In some embodiments, FIG. 6A shows method 600A containing the steps 610-630 that may be performed by the control system 100.

At step 610, the method 600A may include receiving a plurality of images of a person by the control system 100. In some embodiments, the plurality of images of the person may be captured by the camera 240. In some embodiments, the person may be a driver or a passenger within the interior of a vehicle. In some embodiments, each of the plurality of images may include visual information regarding the person's state. In some embodiments, the person's state may be represented by the person's facial expression, the person's head movement, the person's hand gesture, or any combination thereof.

At step 620, the method 600A may include processing, by the control system 100, each of the plurality of images to obtain a set of person state indicators characterizing the person's states. Different state indicators, including facial expression indicators, head movement indicators, and hand gesture indicators, may be used to characterize the person's current state.

In some embodiments, a set of facial expression indicators are provided to characterize all detectable facial expressions of the person, such as smile, wink, eye squinting, etc. Each facial expression indicator may represent a particular facial expression of the person. When the control system 100 detects a facial expression of the person in the images captured by the camera 240, the control system 100 may output a corresponding facial expression indicator. In some embodiments, a set of hand gesture indicators are provided to characterize all detectable hand gestures of the person, such as hand waving, thumb up, thumb down, victory gesture, etc. Each hand gesture indicator may represent a particular hand gesture of the person. When the control system 100 detects a hand gesture of the person in the images captured by the camera 240, the control system 100 may output a corresponding hand gesture indicator. In some embodiments, a set of head movement indicators are provided to characterize all detectable head movement of the person, such as head turning left, head turning right, head roll, head up, and head down, etc. Each head movement indicator may represent a particular head movement of the person in the image captured by the camera 240. When the control system 100 detects a head movement of the person in the images captured by the camera 240, the control system 100 may output a corresponding head movement indicator.

In some embodiments, each of facial expression indicators, each of head movement indicators, and each of hand gesture indicators may be represented by a likelihood number normalized within the range [0, 1], the numeric value of which represents the extent of the person's facial expression, the extent of the person's head movement, or the hand gesture of the person. In some embodiments, different numeric thresholds may be applied to each of the set of facial expression indicators, each of the set of head movement indicators, and each of the set of hand gesture indicators. The method 600A further includes comparing, by the control processor 120 of the control system 100, the numeric value representing a particular facial expression indicator output by the ML model with the corresponding numeric threshold for the particular facial expression indicator, and determining that the numeric value representing the facial expression indicator equals to or is greater than the numeric threshold for the facial expression indicator. Only when the numeric value representing the facial expression indicator equals to or is greater than the numeric threshold, the control processor 120 triggers a command to be sent to the assistant system 400 to instruct the assistant system 400 to respond to the person's facial expression, for example, by displaying one or more animated visual presentations. Similarly, the control processor 120 may compare the numeric value representing a particular head movement indicator with the corresponding numeric threshold for the particular head movement indicator, and determine that the numeric value representing the head movement indicator equals to or is greater than the numeric threshold. Only when the numeric value representing the head movement indicator equals to or is greater than the numeric threshold, the control processor 120 triggers a command to be sent to the assistant system 400 to instruct the assistant system 400 to respond to the person's head movement, for example, to physically move the head 210 of the assistant device 200.

At step 630, the method 600A may include sending commands, by the processor 120 of the control system 100, to the assistant system 400 to instruct the assistant system 400 to provide a response to the person's states. In some embodiments, the response may be displaying an animated visual presentation imitating (i.e., under the mirroring or reversed-mirroring interaction modes) the current facial expression of the person and/or current hand gesture of the person. In these cases, each command may include a facial expression indicator and/or a hand gesture indicator. In some embodiments, the response may be a physical movement of the head 210 of the assistant device 200 to imitate the current head movement of the person. In these cases, each command may include a head movement indicator. In some embodiments, a command may be used to convey multiple person state indicators, such as the facial expression indicator, the hand gesture indicator, and the head movement indicator. In such case, the command may contain multiple data fields. One or more data fields may contain the facial expression indicator, one or more data fields may contain the head movement gesture, and one or more data fields may contain the hand gesture indicator.

In some embodiments, the steps 640-680 of the method 600B shown in FIG. 6B may be performed by the assistant system 400. At step 640, the method 600B may include receiving, by the assistant processor 420 of the assistant system 400, the commands sent from the control system 100, and parsing each command to obtain the facial expression indicator, the hand gesture indicator, and/or the head movement indicator.

At step 650, the method 600B may include constructing a plurality of keyframes, by the assistant processor 420 of the assistant system 400, based on the commands. Specifically, the plurality of keyframes may be constructed based on the facial expression indicator and/or the hand gesture indicator contained in the commands. In some embodiments, a keyframe of an animated visual presentation may include a facial component, a hand component, an accessory component, a background component, or any combination thereof. In some embodiments, the facial component of the keyframe may imitate the current facial expression of the person. The hand component of the keyframe may imitate the current hand gesture of the person. The accessory component and the background component may include images to provide a vivid context for interactions between the assistant device 200 and the person.

In some embodiments, constructing a keyframe may include generating the facial component 330 using a facial element selected from a set of facial elements. As described above, to characterize the person's facial expression, a set of facial elements are constructed using splines and stored in a database in the assistant storage device 410 of the assistant system 400. Each facial expression indicator correlates to a particular facial element. Some examples of the facial elements are shown in FIG. 4A. Thus, generating the facial component 330 may include determining a particular facial element from the set of facial elements according to the facial expression indicator. In some embodiments, constructing a keyframe may include generating the hand component 310 using a hand element selected from a set of hand elements. As described above, to characterize the person's hand gestures, a set of hand elements could be stored in a database in the assistant storage device 410 of the assistant system 400. Each hand gesture indicator correlates to a particular hand element. Some examples of the hand elements are shown in FIG. 4B. Thus, generating the hand component may include determining a particular hand element from the set of hand elements according to the hand gesture indicator.

In some embodiments, constructing a keyframe may include generating the accessory component 320 using an accessory element selected from a set of accessory elements. As described above, a set of accessory elements could be stored in a database in the assistant storage device 410 of the assistant system 400. Some examples of the accessory elements are shown in FIG. 4C. The assistant processor 420 of the assistant system 400 may select one accessory element from the set of accessory elements to generate the accessory component 320. As discussed above, under the mirroring interaction mode or reversed-mirroring interaction mode, the facial component is generated to mirror or reversely mirror the person's present facial expression, and the hand component is generated to mirror or reversely mirror the person's present hand gesture. Unlike the facial component 330 and the hand component 310, the accessory component 320 could be independently generated. The accessory component 320 may not be limited to correspond to a particular facial expression or a particular hand gesture of the person.

In some embodiments, constructing a keyframe may include generating the background component 340 using a background element selected from a set of background elements. As described above, a set of background elements may be stored in a database in the assistant storage device 410 of the assistant system 400. The assistant processor 420 of the assistant system 400 may select one background element from the set of background elements to generate the background component 340. Unlike the facial component 330 and the hand component 310, the background component 340 could be independently generated. The background component 340 may not be limited to correspond to a particular facial expression or a particular hand gesture of the person.

At step 660, the method 600B may include animating the plurality of keyframes, by the assistant processor 420 of the assistant system 400, to form one or more animated visual presentations. In some embodiments, interpolation may be performed to form transitional frames between adjacent keyframes at a predetermined frame rate.

At step 670, the method 600B may include displaying the one or more animated visual presentations on the screen 230 of the assistant device 200.

At step 680, the method 600B may include controlling movement of the assistant device 200 based on the head movement indicator contained in the command. An example assistant device 200 is shown in FIG. 5. As illustrated, the assistant device 200 may include three motors 510, 520, and 530 to control rotations of the head 210 of the assistant device 200 around pitch, roll, and yaw axis. As described above, a set of motion vectors are stored in the assistant storage device 410 of the assistant system 400. Each motion vector correlates to a particular head movement indicator. Thus, controlling movement of the assistant device 200 may include control the rotation of the motors 510-530 according to a particular motion vector selected from the set of motion vectors according to the head movement indicator.

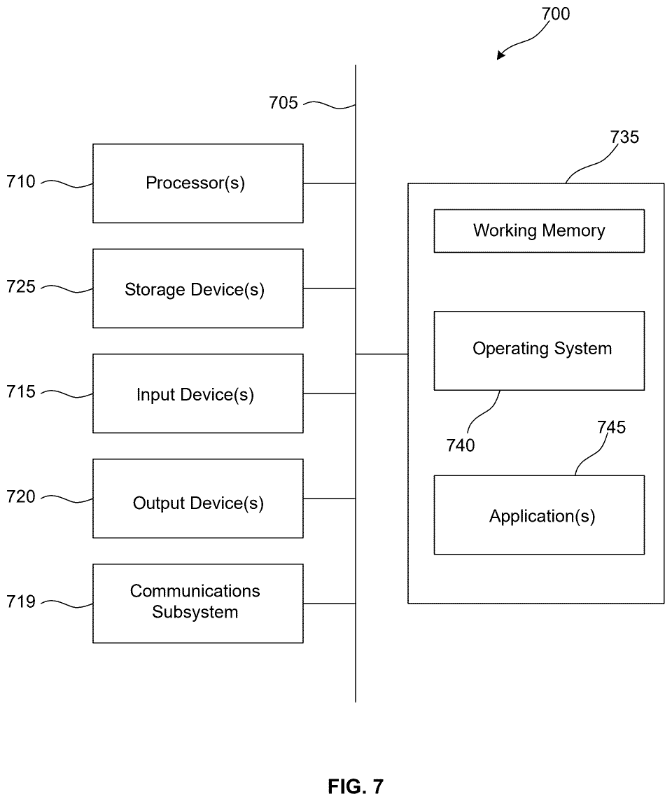

FIG. 7 is a simplified schematic diagram illustrating a computing system 700 according to an embodiment described herein. Computing system 700 as illustrated in FIG. 7 may be used as the control system 100 or the assistant system 400 as described herein. FIG. 7 provides a schematic illustration of one embodiment of computing system 700 that can perform some or all of the steps of the methods provided by various embodiments. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

Computing system 700 is shown comprising hardware elements that can be electrically coupled via a bus 705, or may otherwise be in communication, as appropriate. The hardware elements may include one or more processors 710, including without limitation one or more general-purpose processors and/or one or more special-purpose processors such as digital signal processing chips, graphics acceleration processors, and/or the like; one or more input devices 715, which can include without limitation one or more cameras, and/or the like; and one or more output devices 720, which can include without limitation one or more display devices, one or more speakers, and/or the like.

Computing system 700 may further include and/or be in communication with one or more non-transitory storage devices 725, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

Computing system 700 might also include a communications subsystem 719, which can include without limitation a modem, a network card (wireless or wired), an infrared communication device, a wireless communication device, and/or a chipset such as a Bluetooth device, an 802.11 device, a WiFi device, a WiMax device, cellular communication facilities, etc., and/or the like. The communications subsystem 719 may include one or more input and/or output communication interfaces to permit data to be exchanged with a network such as the network described below to name one example, other computing systems, and/or any other devices described herein. Depending on the desired functionality and/or other implementation concerns, a portable electronic device or similar device may communicate image and/or other information via the communications subsystem 719. In some embodiments, computing system 700 will further comprise a working memory 735, which can include a RAM or ROM device, as described above.

Computing system 700 also can include software elements, shown as being currently located within the working memory 735, including an operating system 740, device drivers, executable libraries, and/or other code, such as one or more application programs 745, which may comprise computer programs provided by various embodiments, and/or may be designed to implement methods, and/or configure systems, provided by other embodiments, as described herein. Merely by way of example, one or more procedures described with respect to the methods discussed above, might be implemented as code and/or instructions executable by a computing device and/or a processor within a computing device; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 725 described above. In some cases, the storage medium might be incorporated within a computer system, such as computing system 700. In other embodiments, the storage medium might be separate from a computing system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by computer system 700 and/or might take the form of source and/or installable code, which, upon compilation and/or installation on computer system 700 e.g., using any of a variety of generally available compilers, installation programs, compression/decompression utilities, etc., then takes the form of executable code.

As mentioned above, in one aspect, some embodiments may employ a computing system such as computing system 700 to perform methods in accordance with various embodiments of the technology. According to a set of embodiments, some or all of the procedures of such methods are performed by computing system 700 in response to processor 710 executing one or more sequences of one or more instructions, which might be incorporated into the operating system 740 and/or other code, such as an application program 745, contained in the working memory 735. Such instructions may be read into the working memory 735 from another computer-readable medium, such as one or more of the storage device(s) 725. Merely by way of example, execution of the sequences of instructions contained in the working memory 735 might cause the processor(s) 710 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using computing system 700, various computer-readable media might be involved in providing instructions/code to processor(s) 710 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 725. Volatile media include, without limitation, dynamic memory, such as the working memory 735.

Common forms of physical and/or tangible computer-readable media include, for example, a floppy disk, a flexible disk, hard disk, magnetic tape, or any other magnetic medium, a CD-ROM (compact disc read only memory), any other optical medium, punchcards, papertape, any other physical medium with patterns of holes, a RAM, a PROM, EPROM (erasable programmable read-only memory), a FLASH-EPROM (Flash erasable programmable read-only memory), any other memory chip or cartridge, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by computer system 700.

The communications subsystem 719 and/or components thereof generally will receive signals, and the bus 705 then might carry the signals and/or the data, instructions, etc. carried by the signals to the working memory 735, from which the processor(s) 710 retrieves and executes the instructions. The instructions received by the working memory 735 may optionally be stored on a non-transitory storage device 725 either before or after execution by the processor(s) 710.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known to those skilled in the art, and so forth.

What is claimed is:

1. A method for in-vehicle interaction, comprising:
receiving commands, by an assistant system, wherein each of the commands contains a set of person state indicators characterizing a person's state at a given time;
parsing, by the assistant system, each of the commands to obtain the set of person state indicators;
constructing, by the assistant system, a plurality of keyframes based on the set of person state indicators;
animating, by the assistant system, the plurality of keyframes to form an animated visual presentation; and
displaying, by the assistant system, the animated visual presentation on a screen of the assistant system.

2. The method of claim 1, wherein the set of person state indicators comprises a facial expression indicator for characterizing the person's facial expression, and each of the keyframes comprises a facial component,
wherein constructing, by the assistant system, the plurality of keyframes based on the set of person state indicators comprises:
generating the facial component on each of the keyframes based on the facial expression indicator.

3. The method of claim 2, wherein generating the facial component on each of the keyframes based on the facial expression indicator comprises:
determining a particular facial element from a set of facial elements, wherein the particular facial element correlates to the facial expression indicator; and
generating the facial component using the particular facial element.

4. The method of claim 1, wherein the set of person state indicators comprises a hand gesture indicator for characterizing the person's hand gesture, and each of the keyframes comprises a hand component,
wherein constructing, by the assistant system, the plurality of keyframes based on the set of person state indicators comprises:
generating the hand component on each of the keyframes based on the hand gesture indicator.

5. The method of claim 4, wherein generating the hand component on each of the keyframes based on the hand gesture indicator comprises:
determining a particular hand element from a set of hand elements, wherein the particular hand element correlates to the hand gesture indicator; and
generating the hand component using the particular hand element.

6. The method of claim 1, wherein each of the keyframes comprises an accessory component,
wherein constructing, by the assistant system, the plurality of keyframes based on the set of person state indicators comprises:
generating the accessory component on each of the keyframes using a particular accessory element independently selected from a set of accessory elements.

7. The method of claim 1, wherein the set of person state indicators comprises a head movement indicator for characterizing the person's head movement, the method further comprises:
causing physical movement of a head of the assistant system based on the head movement indicator.

8. The method of claim 7, wherein causing physical movement of the head of the assistant system based on the head movement indicator comprises:
determining a particular motion vector from a set of motion vectors, wherein the particular motion vector correlates to the head movement indicator; and
controlling rotation of motors mounted on the assistant system according to the particular motion vector.

9. The method of claim 1, further comprises:
receiving, by a control system, a plurality of images of the person, wherein each of the plurality of images comprises visual information regarding the person's state;
processing, by the control system, each of the plurality of images to obtain the set of state indicators characterizing the person's states; and
sending, by the control system, commands to the assistant system, wherein each of the commands contains the set of person state indicators.

10. The method of claim 9, wherein the set of person state indicators includes a facial expression indicator, a hand gesture indicator, a head movement indicator, or any combination thereof, the method further comprises:
storing a predetermined numeric threshold corresponding to each of the person state indicators in the set of person state indicators; and
determining that at least one person state indicator in the set of person state indicators has a numeric value that equals to or is greater than the predetermined numeric threshold corresponding to the at least one person state indicator.

11. An in-vehicle interactive system comprising an assistant system including a screen, a hardware portion, an assistant storage device, and an assistant processor, the assistant storage device storing instructions which, when executed by the assistant processor, causes the assistant system to:
receive commands, wherein each of the commands contains a set of person state indicators characterizing a person's state at a given time;
parse each of the commands to obtain the set of person state indicators;
construct a plurality of keyframes based on the set of person state indicators;
animate the plurality of keyframes to form an animated visual presentation; and
display the animated visual presentation on the screen of the assistant system.

12. The in-vehicle interactive system of claim 11, wherein the set of person state indicators comprises a facial expression indicator for characterizing the person's facial expression, and each of the keyframes comprises a facial component,
wherein constructing the plurality of keyframes based on the set of person state indicators comprises:
generating the facial component on each of the keyframes based on the facial expression indicator.

13. The in-vehicle interactive system of claim 12, wherein generating the facial component on each of the keyframes based on the facial expression indicator comprises:
determining a particular facial element from a set of facial elements, wherein the particular facial element correlates to the facial expression indicator; and
generating the facial component using the particular facial element.

14. The in-vehicle interactive system of claim 12, wherein the set of person state indicators comprises a hand gesture indicator for characterizing the person's hand gesture, and each of the keyframes comprises a hand component,
wherein constructing the plurality of keyframes based on the set of person state indicators comprises:
generating the hand component on each of the keyframes based on the hand gesture indicator.

15. The in-vehicle interactive system of claim 14, wherein generating the hand component on each of the keyframes based on the hand gesture indicator comprises:
determining a particular hand element from a set of hand elements, wherein the particular hand element correlates to the hand gesture indicator; and
generating the hand component using the particular hand element.

16. The in-vehicle interactive system of claim 11, wherein each of the keyframes comprises an accessory component,
wherein constructing the plurality of keyframes based on the set of person state indicators comprises:
generating the accessory component on each of the keyframes using a particular accessory element independently selected from a set of accessory elements.

17. The in-vehicle interactive system of claim 11, wherein the set of person state indicators comprises a head movement indicator for characterizing the person's head movement, and wherein execution of the instructions further causes the assistant system to:
cause physical movement of the hardware portion based on the head movement indicator.

18. The in-vehicle interactive system of claim 17, wherein causing physical movement of the hardware portion based on the head movement indicator comprises:
determining a particular motion vector from a set of motion vectors, wherein the particular motion vector correlates to the head movement indicator; and
controlling rotation of motors mounted on the hardware portion based on the particular motion vector.

19. The in-vehicle interactive system of claim 11, further comprising a control system communicatively coupled with the assistant system, the control system comprising a control storage device and a control processor, the control storage device storing instructions which, when executed by the control processor, causes the control system to:
receive a plurality of images of the person, wherein each of the plurality of images comprises visual information regarding the person's state;
process each of the plurality of images to obtain the set of person state indicators characterizing the person's states; and
send commands to the assistant system, wherein each of the commands contains the set of person state indicators.

20. The in-vehicle interactive system of claim 19, wherein the set of person state indicators includes a facial expression indicator, a hand gesture indicator, a head movement indicator, or any combination thereof, and wherein execution of the instructions further causes the control system to:
store a predetermined numeric threshold corresponding to each of the person state indicator in the set of person state indicators; and
determine that at least one person state indicator in the set of person state indicators has a numeric value that equals to or is greater than the predetermined numeric threshold corresponding to the at least one person state indicators.
